(19) United States
(12) Patent Application Publication
(10) Pub. No.: US 2026/0248080 A1
(43) Pub. Date: Aug. 27, 2026

(54) MULTI-USE CONTAINER FOR CULTIVATION

(71) Applicant: Nelson Garden AB, Tingsryd (SE)

(72) Inventors: Niklas Hjelm, Lomma (SE); Niclas Lundius Mörck, Lund (SE)

(21) Appl. No.: 18/877,332

(22) PCT Filed: Jun. 16, 2023
(86) PCT No.: PCT/SE2023/050610

§ 371 Date: Dec. 20, 2024

(30) Foreign Application Priority Data
Jul. 7, 2022 (SE) SE2250859-2

(51) Int. Cl. A01G 9/04; A01G 9/029

(52) U.S. Cl. CPC A01G 9/042; A01G 9/0295; A01G 9/0299; A01G 9/047

(57) ABSTRACT

The present disclosure relates generally to a multi-use container for cultivation having a planar bottom comprising a first surface and an opposing second surface. The container has planar lateral walls extending upwards from the bottom, the bottom and the lateral walls defining a first cultivation volume. At least one of the lateral walls comprises a drainage opening arranged in a lower half of the lateral. The multi-use container further comprises at least two supports arranged on the second surface of the planar bottom, wherein said at least two supports extend from the second surface in a direction opposite to the lateral walls. The second surface of the planar bottom and the at least two supports define a grow mat receiving volume. Furthermore, the bottom comprises one or more second drainage channels arranged on the second surface.

### TECHNICAL FIELD

The present disclosure relates generally to a multi-use container for cultivation, wherein the container comprises a first cultivation volume and a grow mat receiving volume. The present disclosure further relates to a cultivation container arrangement comprising said multi-use container and a second container being complementary with the multi-use container.

### BACKGROUND

There is a growing trend to self-cultivate plants, especially edible plants. As such, there is an expanding market for equipment especially adapted for indoor cultivation, as this enables users to cultivate in their own homes.

A popular type of edible plants to self-cultivate indoors at home are microgreens. Microgreens are defined in the food trade as greens, lettuces and herbs which are harvested just after the cotyledon leaves have developed with one set of true leaves. Microgreens are used in a variety of ways, such as nutrition supplements, visual enhancement in food preparation, and flavour enhancement.

Traditionally, plants, seeds, seedlings or microgreens have been cultivated using soil as medium. However, in some instances, it is not always desirable to have a large amount of soil indoors as the soil can attract insects or contain undesirable microorganisms that are harmful. Another drawback of soil is that it often contains bacteria which are undesirable in food. It is therefore common to replace soil with other grow mediums when handling edible plants. For the instances where soil is not desirable, different solutions have been developed.

One common solution to the above-mentioned problem is to utilize a grow mat instead of soil, sometimes also referred to as hydroponic gardening. When cultivating using a grow mat, the soil is substituted for a mat made for instance from fibres or other natural materials.

When cultivating using either soil or a grow mat in a hydroponic growing system, it is important to ensure an efficient drainage so not to have excess water in the cultivation container. If an excess of water is present in the cultivation container, standing water can be formed at the bottom of the container, which can lead to fungal formation or damage to the plant's roots.

Grow mats are sometimes not a suitable or desirable option depending on the type of plant to be cultivated. For instance, plants developing extensive roots might not be suitable for grow mats. Therefore, it would be desirable for consumers to have a cultivation container suitable for both soil-based cultivation and grow mat-based cultivation. This would provide benefits both from a utilisation perspective, but also economical as one less product is needed, and from a storage perspective.

As such, there is a need for a cultivation container that can be used either for soil-based cultivation, or for cultivation using a grow mat, depending on current need, and that ensures good drainage for both cultivation techniques, thus solving the above stated problems.

### SUMMARY

An object of at least some implementations of the present disclosure is to provide a multi-use container suitable both for soil-based cultivation and cultivation using a grow mat. By multi-use is meant a container that depending on a user's need, can be used either for cultivating using soil, or using a grow mat.

A further object of embodiments of the present disclosure is to provide a multi-use container providing good water drainage from a first cultivation volume and from a second cultivation volume.

Another object of embodiments of the present disclosure is to provide a cultivation container arrangement comprising a multi-use container and a second container. Thereby, a multi-use container can be positioned inside the second container and water drained from the multi-used container is contained inside the second container.

In a general aspect, the present disclosure is directed to a multi-use container for cultivation. The container having a planar bottom and lateral walls extending upwards from the planar bottom, wherein the lateral walls have a height extending upwards from the planar bottom. Further, the planar bottom and the lateral walls define a first cultivation volume. The planar bottom has a first surface facing the first cultivation volume and a second surface opposite to said first surface, said second surface facing away from the first cultivation volume. At least one of the lateral walls comprises a drainage opening arranged in a lower half of the lateral wall, the lower half being closest to the planar bottom. Further, the container comprises at least two supports arranged on the second surface of the planar bottom, the at least two supports being located essentially at lateral extremities of the second surface, and wherein said at least two supports extend from the second surface in a direction opposite to the lateral walls. The second surface of the planar bottom and the at least two supports defining a grow mat receiving volume, and wherein the at least two supports are arranged on opposite lateral extremities of the second surface. Further, the planar bottom comprises one or more second drainage channels arranged on the second surface.

An exemplary effect of the multi-use container according to what is disclosed herein, is that the container may be used either for soil-based cultivation or cultivation using a grow mat. By this, a more efficient container is achieved as the container can fulfil two purposes. The at least two supports arranged on the second surface provide the multi-use container with means to keep a grow mat in position, as the grow mat is to be inserted in the volume defined between the second surface of the planar bottom and the at least two supports. Furthermore, when the multi-use container is used for soil-based cultivation, i.e. when the first surface is facing upwards, the at least two supports arranged on the second surface function as means elevate the multi-use container from the ground, thus facilitating water drainage from the drainage opening.

An exemplary effect of the multi-use container according to what is disclosed herein, is that water drainage in the first cultivation volume is provided by the drainage opening.

The second drainage channels arranged on the second surface ensure that good water drainage is also achieved when utilizing the multi-use container with a grow mat, i.e. when the second surface is facing upwards. As such, a more efficient water distribution out of the grow mat receiving volume is achieved, as excess water or standing water collected under the grow mat may be directed outwards from the multi-use container.

The lateral walls may be essentially perpendicular to the planar bottom of the multi-use container. The at least two supports may be located at lateral extremities of the second surface.

In one exemplary multi-use container, the at least two supports are arranged as one support at a first lateral extremity and another support at one a second lateral extremity opposed to the first lateral extremity.

In one exemplary multi-use container, the drainage opening comprises a first drainage opening at a first of the lateral walls and a second drainage opening at a second of the lateral walls opposite the first lateral wall.

By having opposing drainage openings, an improved water drainage is achieved in the multi-use container.

In one exemplary multi-use container, the at least one drainage opening is located at a height of its lateral wall that is less than ⅓ of the total height of the lateral wall, when measuring the total height of the lateral wall from the second surface of the planar bottom to an end of the wall opposite to the planar bottom, preferably at a height of the lateral wall where the at least one drainage opening is located is less than ⅕ of the total height of the lateral wall.

By such an exemplary multi-use container, an improved water drainage is achieved in the multi-use container.

In one exemplary multi-use container, the at least one drainage opening is located at a height of its lateral wall so that the at least one drainage opening is in flush with the first surface of to the planar bottom.

In one exemplary multi-use container, the drainage opening is a horizontal drainage opening.

The multi-use container may comprise a plurality of drainage openings. The drainage openings can have a variety of shapes, such as circular, elongated, or square for instance.

In one exemplary multi-use container, the planar bottom comprises one or more first drainage channels arranged on the first surface, wherein the one or more first drainage channels extends towards the at least one lateral wall having a drainage opening.

This means that when the drainage opening comprises a first drainage opening at a first of the lateral walls and a second drainage opening at a second of the lateral walls opposite the first lateral wall, the channels extend from the first of the lateral walls comprising a first drainage opening towards the second of the lateral walls comprising a second drainage opening.

By having one or more first drainage channels arranged on the first surface, an even more efficient water distribution out of the first cultivation volume is achieved, as excess water or standing water collected at the bottom of the first cultivation volume may be directed towards the drainage opening.

In one exemplary multi-use container, the one or more second drainage channels extends essentially parallel to the one or more first drainage channels. In one exemplary multi-use container, the one or more second drainage channels extend parallel to the one or more first drainage channels.

By such a multi-use container, water exits the multi-use container from the same side or sides of the multi-use container in both utilization positions of the container, i.e. both when the first surface is facing upwards or when the second surface is facing upwards.

In one exemplary multi-use container, the container comprises ridges arranged on the second surface of the planar bottom, the ridges being arranged on two opposite lateral extremities of the second surface, wherein the ridges extend downwards in a direction opposite to the lateral walls, and wherein the at least two supports are placed on said ridges.

The ridges help to keep a grow mat inserted in the grow mat receiving volume in the correct position. Furthermore, the ridges also ensure that water exits the multi-use container in a more controlled manner, as water will exit from the two opposing lateral extremities of the second surface not comprising ridges.

In one exemplary multi-use container, the at least two supports are arranged at each corner of the second surface.

In one exemplary multi-use container, the container comprises protrusions arranged on the first surface facing upwards from the first surface, wherein the protrusions are configured to engage with an insert to be placed in the first cultivation area, wherein each protrusion engages with a corresponding opening located at the bottom part of the insert, thereby keeping the insert in position.

The insert can be advantageously used when cultivating certain plants, or for propagating growth of seedlings.

In one exemplary multi-use container, the container further comprises at least one drainage hole extending through the planar bottom.

The at least one drainage hole ensure an even more efficient water drainage from the first surface or second surface, depending on which one is facing upwards. If the drainage hole is present, excess water can exit from both the drainage opening (lateral drainage), and though the drainage hole (vertical drainage).

In one exemplary multi-use container, the lateral walls are arranged at each side end of the rectangular planar bottom. In one exemplary multi-use container, the container comprises four lateral walls, each lateral wall being arranged on a side end of the rectangular planar bottom. In a second general aspect, the present disclosure is directed to a cultivation container arrangement comprising a multi-use container according to what is described herein, and a second container having a bottom and a plurality of lateral walls extending upwards from the bottom, the second container being complementary with the multi-use container and having larger dimensions than the multi-use container, whereby the multi-use container can be positioned inside the second container.

An exemplary effect of a cultivation container arrangement according to what is disclosed herein, is that water is collected in a controlled manner from the multi-use container, thus facilitating the use of the multi-use container in an indoor environment.

### BRIEF DESCRIPTION OF DRAWINGS

The disclsoure is now described, by way of example, with reference to the accompanying drawings, in which the same reference notations denote similar items in the various figures, and in which:

FIG. 1 schematically shows a multi-use container in a perspective top side view. In FIG. 1, a first surface of a planar bottom is facing upwards.

FIG. 2 schematically shows a multi-use container in a top view. In FIG. 2, a second surface of the planar bottom, opposite the first surface is facing upwards.

FIG. 3 schematically shows the multi-use container a in a side view.

FIG. 4 schematically shows a multi-use container in a perspective side view.

FIG. 5 schematically shows a cultivation container arrangement comprising the multi-use container of FIGS. 1-4 and a second container.

### DETAILED DESCRIPTION

The detailed description with reference to the disclosed embodiments are to be viewed as examples of combining specific features described above. It is to be understood that additional examples may be achieved by combining other and/or fewer/more features than in the disclosed embodiments. Hence, the figures disclose exemplary embodiments and not exclusive combinations. In this context is should also be noted that, for the sake of simplicity, all figures are schematically disclosed, as long as nothing else is said.

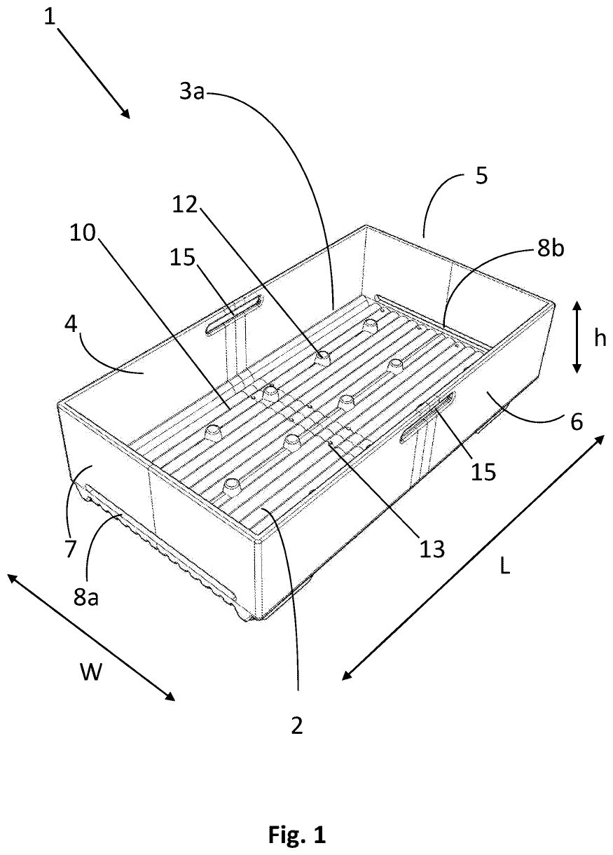

FIGS. 1-4 show a multi-use container 1 according to an embodiment of the present disclosure, illustrated from different sides and perspectives.

FIG. 1 shows a schematic representation of a multi-use container 1 in a perspective side view in accordance with one embodiment of the present disclosure. The multi-use container 1 illustrated in FIG. 1 has a planar bottom 2 and four lateral walls 4-7 extending upwards from the planar bottom 2. As the lateral walls 4-7 have a height (h), they define with the planar bottom 2 a first cultivation volume. The planar bottom 2 further comprises a first surface 3a facing the first cultivation volume. The first cultivation volume may be filled with soil or any other suitable solid growing medium when used for cultivation.

The multi-use container 1 according to the embodiment illustrated in FIG. 1 has an elongated form where the extension of a first pair 4, 6 of opposing walls of the lateral walls 4-7 define a length L of the multi-use container 1, and the extension of a second pair 5, 7 of opposing walls of the lateral walls 4-7 define a width W of the multi-use container 1.

The second pair of lateral walls 5, 7 comprises horizontal drainage openings 8a, 8b arranged in a lower half of the height of the second pair of lateral walls 5, 7 closest to the planar bottom 2. It is preferable to place the drainage openings 8a, 8b sufficiently low on the second pair of lateral walls 5, 7 so that water to be drained can efficiently leave the first cultivation volume of the multi-use container 1.

The multi-use container according to the embodiment illustrated in FIG. 1 further comprises a plurality of first drainage channels 10 arranged on the first surface 3a of the planar bottom 2. As illustrated in FIG. 1, the plurality of first drainage channels 10 extend towards the drainage openings 8a, 8b located on the second pair of lateral walls 5, 7. i.e. the short sides of the multi-use container 1. However the drainage openings 8a, 8b can also be located on the first pair of lateral walls 4, 6, i.e. on the long sides, of the multi-use container 1. In such an embodiment, the plurality of first drainage channels extend towards the first pair of lateral walls 4, 6. By letting the plurality of first drainage channels 10 extend towards the drainage openings 8a, 8b, an efficient water drainage of excess water present in the first cultivation volume is achieved. The first drainage channels 10 can have a multitude of shapes and sizes. They can for instance be formed as indentations on the first surface 3a, or as gutters placed on the first surface 3a. In the embodiment illustrated in FIG. 1, the drainage channels 10 extend in a parallel direction. The embodiment in FIG. 1 further illustrates that the drainage channels 10 extend all the way between the opposing second pair of lateral walls 5, 7.

The multi-use container 1 according to the embodiment illustrated in FIG. 1 further comprises a plurality of protrusions 12 arranged on the first surface 3a and facing upwards from the first surface 3a. The protrusions 12 are configured to engage with an insert (not shown in FIG. 1) to be placed in the first cultivation volume. Each protrusion 12 is configured to engage with a corresponding opening located at the bottom part of the insert. As such, the protrusions 12 keep the insert in place. The insert can be advantageously used when cultivating certain plants, or for propagating growth of seedlings. For instance, the insert can be a container that fits within the first cultivation volume defined by the first surface 3a and the lateral walls 4-7, comprising individual plant receptacles. However, other inserts are possible to utilise as well.

The multi-use container 1 according to the embodiment illustrated in FIG. 1 further comprises a plurality of drainage holes 13 extending through the planar bottom 2. The drainage holes 13 further improves the drainage of the multi-use container 1 as any excess water residing in the first cultivation volume can flow through the drainage holes and out of the container.

As also illustrated in FIG. 1, the multi-use container 1 further comprises handles 15 arranged on an upper part of the first pair of lateral walls 4, 6. These handles 15 improve the ease of use for a user when managing the multi-use container 1. The handles 15 are made as long, narrow openings so that means for carrying the multi-use container 1 can be inserted into the openings. The means for carrying the multi-use container 1 may be bands or any other suitable carrying means.

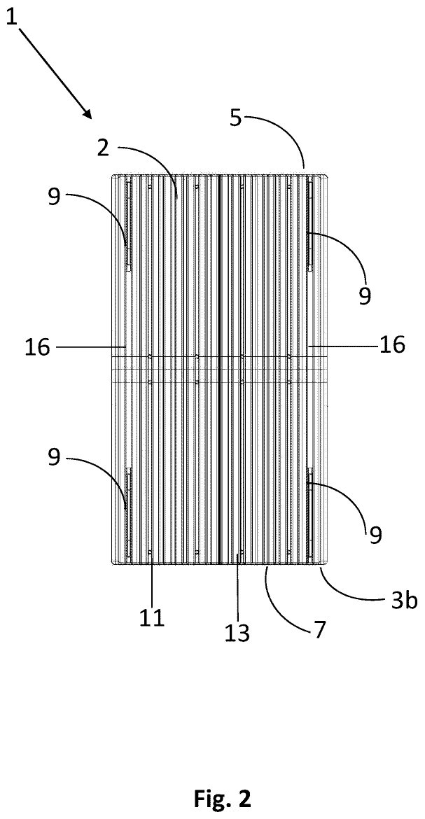

Turning now to FIG. 2, illustrating a schematic representation of the multi-use container 1 in a perspective side view where the container 1 has been turned upside-down compared to in FIG. 1. As can be seen in FIG. 2, the planar bottom 2 of the multi-use container 1 comprises a second surface 3b opposite to the previously described first surface 3a (not illustrated in FIG. 2). In FIG. 2, the second surface 3b is facing upwards. The multi-use container 1 as illustrated in FIG. 2 further comprises four supports 9 arranged at each corner of the second surface 3b. As previously described, the supports 9 provide the multi-use container with several advantages, such as holding a grow mat in position, improved drainage and improved stability support. The four supports 9 form together with the second surface 3b of the planar bottom 2 a grow mat receiving volume. The grow mat receiving volume is opposite to the first cultivation volume in relation to the planar bottom 2.

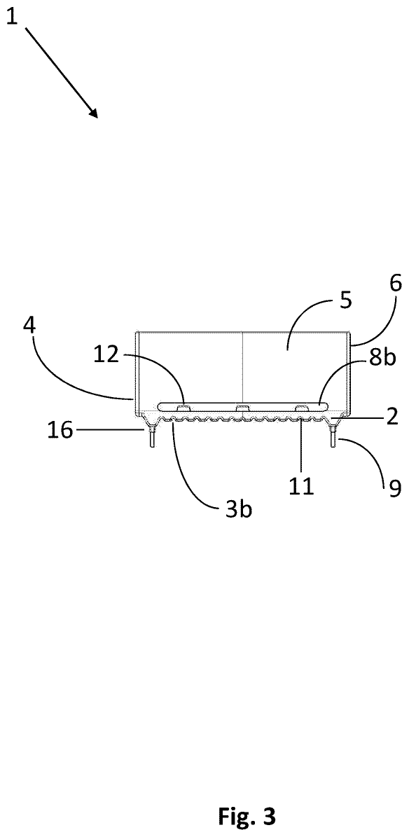

In the embodiment illustrated in FIGS. 2, 3 respectively 4, the supports are arranged on two ridges 16 on the second surface 3b extending in the same direction as the lateral walls 4, 6. The ridges in FIG. 2 are parallel to the first pair of lateral walls 4, 6 of the multi-use container 1, and are placed underneath said first pair of lateral walls 4, 6.

The multi-use container 1 according to FIG. 2 further comprises a plurality of second drainage channels 11 arranged on the second surface 3b. These second drainage channels 11 ensure that good water drainage is also achieved when utilizing the multi-use container with a grow mat. In the embodiment illustrated in FIG. 2, the second drainage channels 11 extend parallel to the supports 9 so that the drainage achieved by the second drainage channels 11 is not hindered by the supports 9. Further, the second drainage channels 11 are parallel to the first drainage channels 10. The second drainage channels 11 can have a multitude of shapes and sizes. They can for instance be formed as indentations on the first surface 3b, or as gutters placed on the first surface 3b. In the embodiment illustrated in FIG. 2 the drainage channels 11 extend all the way between the second pair of lateral walls 5-7.

As previously described, the multi-use container 1 comprises a plurality of drainage holes 13 extending through the planar bottom 2. The openings of the drainage holes 13 present on the second surface 3b are visible in FIG. 2.

FIG. 3 schematically shows a side view of a multi-use container 1 in a perspective side view in accordance with one embodiment of the present disclosure. In FIG. 3, the multi-use container is viewed facing one of the walls 5 of the second pair of lateral walls and with the first surface facing upwards. In the embodiment in FIG. 3, the protrusions 12 arranged on the first surface are visible through the drainage opening 8b. On the lower surface of the planar bottom 2, i.e. the second surface 3b, the second drainage channels 11 are arranged for improving the water drainage of the grow mat receiving volume defined by the second surface 3b and two supports 9. In the embodiment illustrated in FIG. 3, the supports 9 are arranged on the two ridges 16 extending through the length of the multi-use container 1.

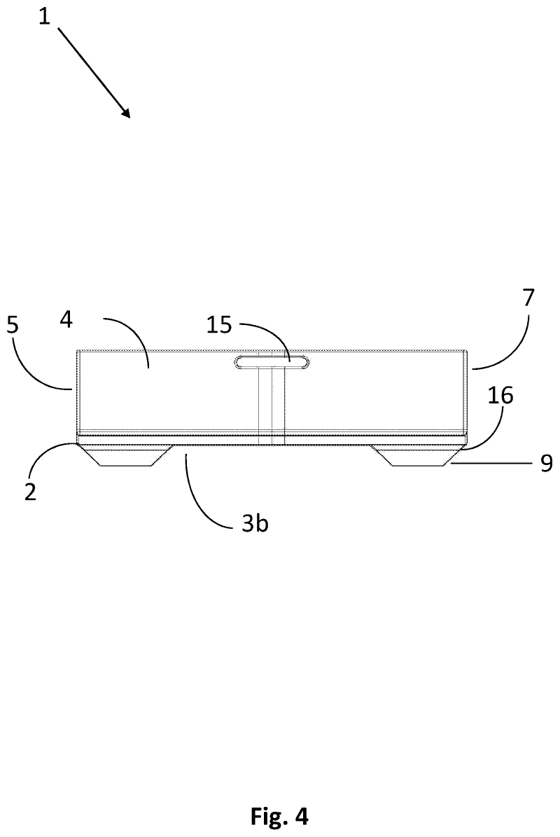

FIG. 4 schematically shows a side view of a multi-use container 1 in a side view in accordance with one embodiment of the present disclosure. In FIG. 4, the multi-use container 1 is viewed facing one of the lateral walls 4 of the first pair of lateral walls and with the first surface facing upwards. Visible on the lateral wall 4 of the first pair of lateral walls is one of the handles 15 in which means for carrying the multi-use container 1 can be inserted. Arranged on the second surface 3b are the ridges 16 with the supports 9 arranged thereon.

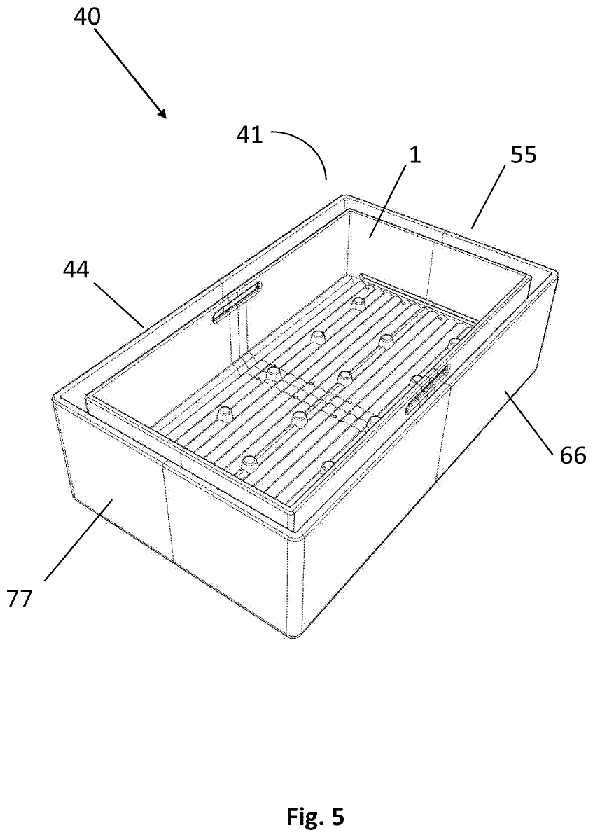

FIG. 5 schematically shows a cultivation container arrangement 40 comprising the multi-use container 1 as described in FIGS. 1-4. The cultivation container arrangement 40 further comprises a second container 41 having a bottom (not shown in FIG. 5) and a plurality of substantially parallel lateral walls 44, 55, 66, 77 extending upwards from the bottom. The multi-use container 1 is in FIG. 5 positioned inside the second container 41. In order to make it possible to put the multi-use container 1 inside the second container 41, the second container 41 has larger dimensions than the multi-use container 1. The cultivation container arrangement as illustrated in FIG. 5 provides an efficient and space saving alternative for both traditional soil-based cultivation and cultivation using a grow mat. The excess water drained through the first and second channels, and the drainage openings, is collected at the bottom of the second container 41.

When the multi-use container 1 is placed in the second container 41 with its first surface 3a facing upwards, as shown in FIG. 5, the supports 9 arranged on the second surface 3b of the planar bottom 2 provides a water collecting space between the bottom of the second container 41, the lateral walls 44, 55, 66, 77 of the second container and the planar bottom 2 of the multi-use container 1 corresponding essentially to the grow mat receiving volume facing downwards. As the drained water hereby is provided a collecting space where to be stored, the drained water is expelled in an efficient manner from the multi-use container 1 and thus reduces the risk of the multi-use container 1 standing in water. By providing a second container 41, the drained water from the drainage openings 8a, 8b, and if present also from the plurality of drainage holes 13, exits from the multi-use container 1 in a controlled manner. As such, the drained water is contained in a contained volume and does not come into contact with a surface on which the multi-use container 1 is placed.

Certain embodiments or components or features of components have been noted herein as being “preferred” and some options as being “preferable” or the like and such indications are to be understood as relating to a preference of the applicant at the time this application was filed. Such embodiments, components or features noted as being “preferred” or “preferable” or the like are optional and are not required for implementation of the innovations disclosed herein unless otherwise indicated as being required, or specifically included within the claims that follow.

1. A multi-use container for cultivation, the container having a planar bottom and lateral walls extending upwards from the planar bottom, wherein the lateral walls have a height extending upwards from the planar bottom, the planar bottom and the lateral walls defining a first cultivation volume, wherein the planar bottom has a first surface facing the first cultivation volume and a second surface opposite to said first surface, said second surface facing away from the first cultivation volume, wherein:
at least one of the lateral walls comprises a drainage opening arranged in a lower half of the lateral wall, the lower half being closest to the planar bottom;
the multi-use container further comprises at least two supports arranged on the second surface of the planar bottom, the at least two supports being located essentially at lateral extremities of the second surface, wherein said at least two supports extend from the second surface in a direction opposite to the lateral walls, wherein the second surface of the planar bottom and the at least two supports defining a grow mat receiving volume, and wherein the at least two supports are arranged on opposite lateral extremities of the second surface; and
wherein the planar bottom comprises one or more second drainage channels arranged on the second surface.

2. The container according to claim 1, wherein the drainage opening comprises a first drainage opening at a first of the lateral walls and a second drainage opening at a second of the lateral walls opposite the first lateral wall.

3. The container according to claim 1, wherein the at least one drainage opening is located at a height of its lateral wall that is less than ⅓ of a total height of the lateral wall, when measuring the total height of the lateral wall from the second surface of the planar bottom to an end of the lateral wall opposite to the planar bottom, wherein the height of the lateral wall where the at least one drainage opening is located is less than ⅕ of the total height of the lateral wall.

4. The container according to claim 1, wherein the at least one drainage opening is located at a height of its lateral wall so that the at least one drainage opening is in flush with the first surface of the planar bottom.

5. The container according to claim 1, wherein the planar bottom comprises one or more first drainage channels arranged on the first surface, wherein the one or more first drainage channels extends towards the at least one lateral wall having a drainage opening.

6. The container according to claim 5, wherein the one or more second drainage channels extend essentially parallel to the one or more first drainage channels.

7. The container according to claim 1, wherein the container comprises ridges arranged on the second surface of the planar bottom, the ridges being arranged on two opposite lateral extremities of the second surface where the at least two supports are situated, wherein the ridges extend downwards in a direction opposite to the lateral walls, and wherein the at least two supports are placed on said ridges.

8. The container according to claim 1, wherein the at least two supports are arranged at each corner of the second surface.

9. The container according to claim 1, wherein the container comprises protrusions arranged on the first surface facing upwards from the first surface, wherein the protrusions are configured to engage with an insert to be placed in the first cultivation area, wherein each protrusion engages with a corresponding opening located at a bottom part of the insert, thereby keeping the insert in position.

10. The container according to claim 1, further comprising at least one drainage hole extending through the planar bottom.

11. The container according to claim 1, wherein the planar bottom of the container is essentially rectangular, preferably wherein the planar bottom of the container is rectangular.

12. The container according to claim 11, wherein the lateral walls are arranged at each side end of the rectangular planar bottom.

13. A cultivation container arrangement comprising the multi-use container according to claim 1 and a second container having a bottom and a plurality of lateral walls extending upwards from the bottom, the second container being complementary with the multi-use container and having larger dimensions than the multi-use container, whereby the multi-use container can be positioned inside the second container.
